(19) United States
(12) Patent Application Publication
(10) Pub. No.: US 2005/0259919 A1
(43) Pub. Date: Nov. 24, 2005

(54) Optical connector arrangement

(76) Inventors: Nigel B. Aldridge, Wotton-under-Edge, Gloucestershire (GB); Ian J. Read, Bristol, South Gloucestershire (GB); Peter D. Foote, Trellech, Gwent (GB)

Correspondence Address: NIXON & VANDERHYE, PC, 901 NORTH GLEBE ROAD, 11TH FLOOR, ARLINGTON, VA, 22203, US

(21) Appl. No.: 10/523,677

(22) PCT Filed: Dec. 21, 2004
(86) PCT No.: PCT/GB04/05393

§ 371 Date: Feb. 4, 2005

(30) Foreign Application Priority Data
Dec. 22, 2003 (GB) 0329642.3
Dec. 22, 2003 (EP) 03258123.3

(51) Int. Cl. G02B 6/34

(52) U.S. Cl. 385/37; 385/31

(57) ABSTRACT

One aspect of the intention provides an optical connector arrangement (100). The optical connector arrangement (100) comprises a connector component (114) embedded in a substrate material (130). The embedded connector component (114) includes a fibre optic grating (110) optically coupled to a reflector (116) for directing radiation emitted from the fibre optic grating (110) to a surface (140) of the substrate material (130). The optical connector arrangement (100) also comprises a surface connector component (120) for collecting radiation emitted from the surface (140) of the substrate material (130).

### FIELD

The present invention relates to an optical connector arrangement. In particular, but not exclusively, the present invention relates to an optical connector arrangement for providing an interface to a surface connector component from a connector component embedded in a substrate material. Such a substrate material may form, for example, a panel forming part of an aircraft structure.

### BACKGROUND

The provision of embedded waveguide structures to provide embedded sensing and/or embedded communication channels provides various known benefits. Where such waveguide structures are provided integrally within, for example, an aircraft, relatively light materials, such as, for example, optical fibres (fibre optics) may be provided, which are not only lighter than traditional metal wiring, but also relatively noise-immune and inexpensive.

While it is desirable to embed waveguide structures within panels that form a larger structure, such as, for example, a building or aircraft, it has proved to be reasonably difficult and time consuming to provide reliable connections to such embedded waveguide structures, particularly during the process of manufacturing or assembly of the larger structure.

Conventionally, to produce a panel, such as a composite panel for an aircraft incorporating an embedded waveguide, a waveguide (such as, for example, a fibre optic) is embedded in the composite panel and emerges from an edge of the panel from where it is terminated into a connector. For example, a so-called flying fibre pigtail may be provided. However, not only are such so-called “edge connectors” labour intensive to produce, but they also place substantial limitations upon any subsequent modification to the panels. This in turn means that it has been necessary to provide a range of different panels of different shapes and sizes to assemble into the larger structure. This not only increases the tooling costs and complexity involved in producing a complex large structure, but also gives rise to a requirement for intensive use of skilled labour capable of making the edge connectors.

Further, for certain applications, it may not be possible to use panels that include edge connectors which include so-called flying leads. Edge connectors can also make panel production more difficult, particularly where such panels are manufactured using a vacuum technique in which the panel is enveloped by a vacuum bag, since such vacuum bags tend to snap edge emerging fibres when a vacuum is being generated.

In order to address the problems associated with panels using edge connectors, and in particular in order to provide a panel that could be shaped after manufacture to allow, for example, for the removal of peripheral defects, the Applicants have previously devised various ways of interfacing to embedded waveguides. Various methods are discussed further in the Applicant's patent applications EP-A1-1,150,145 and EP-A1-1,150,150, the contents of which are hereby incorporated herein by reference in their entirety.

The aforementioned patent applications describe various ways of interfacing optical fibres incorporated into components made using composite materials to surface-mountable interface modules. The optical fibres are accessed from the surface of the components post-manufacture in order to leave the surface of the components free of incisions, cavities and the like during the assembly of various components into a large structure, such as, for example, an aircraft body.

While embedding of optical fibres and various interfacing components within a substrate, such as a composite material, can facilitate assembly of such a larger structure, since waveguide connections can be made post-assembly, this approach is not without certain drawbacks. Processing of the substrate structure to reveal embedded components with which to interface can be difficult and time-consuming. This is partly because the components must first be located and then subsequently exposed. Ease of exposure of components may also be hindered as the substrate structure will already be part of the larger structure which may in turn make accessibility an issue when attempting to “dig out” or expose the interface components. Furthermore, the task of exposing the embedded components calls not only for a skilled technician, but also requires the use of specialist equipment.

By having to process substrates to expose connector components, any surface finishing of the substrate is also disrupted. Moreover, connectors provided to such exposed components tend to be bulky and may project above the surface of the substrate by a significant amount. This can make connectors formed using this technique susceptible to being inadvertently damaged or disconnected, for example, should they be accidentally knocked.

Additionally, aligning, processing and coupling exposed connector components with other elements needed to form a connector can be difficult and is also time consuming. This can in turn lead to the manufacture of a connector having sub-optimal alignment, finishing, polishing, etc., thereby leading to a connector having relatively high insertion and/or coupling losses.

It is also generally undesirable, post-assembly into a larger structure, to process substrates either near to the edges or the centre of the substrate surface, since this increases the chance of weakening substrates and also may mean that they become damaged, possibly resulting in a need for their subsequent removal and replacement. Moreover, waveguide interfaces produced by exposing embedded components cannot be tested until they have been formed post-exposure, thereby introducing a risk that a defective panel be included in the large structure. This could in turn necessitate subsequent remedial attention, such as replacement of a section of structure, for example, a full aircraft panel, despite the expenditure of the time and effort needed to expose the previously embedded components of the defective panel.

Various techniques relating to the use of fibre optic components and/or embedding of fibre optic components into substrate structures may also be found in the following documents, the teachings of all of which are hereby incorporated herein by reference in their entirety: “Termination and connection methods for optical fibres embedded in aerospace composite components,” A. K. Green and E. Shafir, Smart Materials and Structures, Volume 8(2), pp. 269-273 (1999); “Optical fiber sensors for spacecraft applications,” E. J. Friebele et al, Smart Materials and Structures, Volume 8(6), pp. 813-838 (1999); “Development of fibre optic ingress/egress methods for smart composite structures,” H. K. Kang et al, Smart Materials and Structures, Volume 9(2), pp. 149-156 (2000); “Infrastructure development for incorporating fibre-optic sensors in composite materials,” A. K. Green et al, Smart Materials and Structures, Volume 9(3), pp. 316-321 (2000); and “Manufacturing technique for embedding detachable fiber-optic connections in aircraft composite components,” A. Sjögren, Smart Materials and Structures, Volume 9(6), pp. 855-858 (2000).

The aforementioned considerations and the documents cited herein have been borne in mind when devising the various aspects and embodiments of the invention, as herein described.

### SUMMARY

According to a first aspect of the invention, there is provided an optical connector arrangement. The optical connector arrangement comprises a connector component embedded in a substrate material that includes a fibre optic grating optically coupled to a reflector for directing radiation emitted from the fibre optic grating to a surface of the substrate material. The optical connector arrangement also includes a surface connector component for collecting radiation emitted from the surface of said substrate material.

According to a second aspect of the invention, there is provided an embeddable connector component for embedding in a substrate material. The embeddable connector component includes a fibre optic grating optically coupled to a reflector for directing radiation emitted from the fibre optic grating to a surface of a substrate material. The embeddable connector component may be used as a connector component of an optical connector arrangement according to the first aspect of the invention.

The reflector may have a curved reflecting surface. Such curved reflecting surfaces can act to reduce the divergence of radiation emitted at the surface of the substrate material and/or to collect light provided from a surface connector component, thereby reducing insertion losses associated with the optical connector arrangement.

Various geometrical shapes may be used to define a reflector surface. In one example, the curved reflecting surface is part of a cylindrical surface. Such cylindrical surfaces can be provided, for example, by machining and reflection coating capillary tubes, thereby allowing for relatively straightforward and inexpensive reflector production. In another example, the curved reflecting surface has a substantially constant part elliptically shaped or parabolically shaped cross-section along its length. Additionally, an axis of the fibre optic grating may lie proximal to a focal point of a part elliptically shaped or parabolically shaped cross-section along at least part of the length of the curved reflecting surface. By providing such part elliptically shaped or parabolically shaped curved reflecting surfaces, optionally with optimised positioning of the grating axis, a substantially collimated beam of radiation can be provided. Such substantially collimated beams provide an improved optical coupling efficiency for the various optical connector arrangements that use them.

Various types of grating may be used. For example, a grating may be a Bragg grating, a slanted/blazed Bragg grating or a long period grating. The grating may be provided integrally with a fibre optic, for example. A Bragg grating acts as a wavelength selective radiation steering device. The physical properties of a Bragg grating dictate the direction in which radiation is steered and the percentage amount of radiation that is steered in any particular direction. Various embodiments use one or more slanted Bragg grating to enable the direction of radiation emitted from a fibre optic to be predetermined. Use of slanted Bragg grating provides an improved optical efficiency and may reduce the need to provide reflectors having accurately shaped profiles.

Examples of various gratings that may be used, including, but not limited to, a slanted Bragg grating, are described in: “Side detection of strong radiation-mode out-coupling from blazed FBGs in single-mode and multimode fibers,” K. Zhou et al, IEEE Photonics Technology Letters, Vol. 15, No. 7, July 2003; “Wide bandwidth high resolution spectral interrogation using a BFBG-CCD array for optical sensing applications,” A. G. Simpson et al, OFS16, Nara, Japan, October 2003; “Two-dimensional optical power distribution of side-out-coupled radiation from tilted FBGs in multimode fibre,” K. Zhou et al, Electronics Letters, Vol. 39, No. 8, 17 Apr. 2003; “Polarisation independent, high resolution spectral interrogation of FBGs using a BFBG-CCD array for optical sensing applications,” A. G. Simpson et al, SPIE, Photonics East, Rhode Island, USA, October 2003; “High accuracy interrogation of a WDM FBG sensor array using radiation modes from a B-FBG,” A. G. Simpson et al, BGPP 2003, Monterey, Calif., USA, September 2003; and “Low-cost in-fiber WDM devices using tilted FBGs,” K. Zhou et al, CLEO 2003, Baltimore, USA, June 2003, the contents of which are hereby incorporated herein in their entirety.

The grating may be bonded to the reflector using an index matching material. This allows the grating and the reflector to maintain a fixed relationship whilst minimising any reflection losses that would otherwise occur should there be an index mismatch. It can also help to inhibit the ingress of materials into an embedded connector that might be used during manufacture of an optical connector arrangement (such as, for example, epoxy resin or components thereof).

One or more grating may be provided in a surface connector component. Such a surface connector component may include an embeddable connector component of the type herein described. In this way, complementary pairs of connector components incorporating gratings may be used to provide an interface between an embedded waveguide coupled to an embedded connector component and a surface module comprising a surface connector component.

The substrate material may comprise one or more composite material layers. By using one or more composite material layers as a substrate material, the substrate can be manufactured with a high strength-to-weight ratio. Moreover, by providing such composite layers, a substrate having predefined mechanical and/or physical parameters may be provided. For example, composite layers having respective fibres aligned in a particular arrangement may be used to tailor an aircraft panel so that it preferentially breaks in a particular predefined place when subject to a predetermined stress.

The embedded connector component may be potted (i.e. affixed by embedding in a potting material, such as, for example, epoxy resin) into a recess in the substrate using an optically transparent material. This can provide a window in the optical connector arrangement that is relatively easy to manufacture. Such optically transparent material may be fitted or machined flush to the surface of the substrate material, thereby providing a relatively smooth surface, devoid of substantial protrusions, which is fairly easy to process: for example, the material may be polished/finished to provide an optical window in the substrate. Provision of a shaped recess in the substrate may also aid in aligning the connector component reflector during the embedding procedure.

The embedded/embeddable connector components may be used in a panel having a connector that is optically accessible (i.e. that provides communication between an embedded connector component and a surface connector component using, for example, UV, visible and/or infrared light) at a surface of the panel. Such panels find use in many applications, such as, for example, for aircraft or motor vehicles. By providing a connector that is optically accessible at a surface of the panel, various embodiments of the invention provide panels which can be machined post-manufacture, without damaging the panel or an embedded connector component, in order for them to be incorporated into, for example, an aircraft structure or a racing car body. Accordingly, various embodiments of the invention enable the manufacture of large structures incorporating embedded waveguides, such as aircraft or other vehicles, to be more efficiently produced.

Furthermore, provision of an optical connector arrangement that is optically accessible at a surface of a substrate allows for rapid and easy connection of surface modules. Such surface modules may have a low profile and/or be securely fixed to the substrate, for example, by bonding an optical window in a panel to a corresponding optical window formed in a surface module incorporating a surface connector. Such bonding may be by way of an index matching substance, thereby providing a low loss coupling between optical windows.

According to a third aspect of the invention, there is provided a panel for an aircraft fuselage, component, body or hull, comprising an optical connector arrangement and/or embeddable connector component according to any of the aspects and/or embodiments herein described. According to a fourth aspect of the invention, there is provided an aircraft comprising a panel according to the third aspect of the invention. According to a fifth aspect of the invention, there is provided a method of manufacturing the aircraft according to the fourth aspect of the invention.

According to a sixth aspect of the invention, there is provided a surface connector component for use in the optical connector arrangement according to any of the aspects and/or embodiments herein described.

According to a seventh aspect of the invention, there is provided a method of manufacturing an optical connector arrangement. The method comprises embedding an embeddable connector component in a substrate material and providing a surface connector component for collecting radiation emitted from the surface of the substrate material. The embeddable connector component includes a fibre optic grating optically coupled to a reflector for directing radiation emitted from the fibre optic grating to a surface of the substrate material. The method may also comprise bonding an optical fibre comprising the grating to the reflector using an index matching material and/or forming the reflector from a cylindrical tube.

The step of embedding the embeddable connector component in a substrate material may comprise providing a plurality of composite material layers to form a composite material. Each such composite material layer may comprise respectively aligned material fibres. Such material fibres may be selected from one or more of the following materials: carbon, glass, metal and Kevlar.

The method may comprise potting the embeddable connector component into a recess in the substrate material using an optically transparent material. This allows for the provision of an optical window through which embedded connector components can be optically accessed. The optically transparent material may be fitted flush to the surface of the substrate material. This can provide a substrate surface that may have one or more surface connector components coupled thereto without having to provide substantial surface processing/finishing to prepare that surface for connecting to one or more surface connectors.

### BRIEF DESCRIPTION OF THE DRAWINGS

Embodiments of the present invention will now be described, by way of example only, with reference to the accompanying drawings where like numerals refer to like parts and in which:

FIG. 1 shows a segment of a fibre optic incorporating a grating for use in a first embodiment of an optical connector arrangement according to the present invention;

FIG. 2 shows an embeddable connector component incorporating the segment of fibre optic of FIG. 1 during assembly into the first embodiment of the optical connector arrangement according to the present invention;

FIG. 3 shows the connector component of FIG. 2 embedded in a support layer during assembly of the first embodiment of the optical connector arrangement according to the present invention;

FIG. 4 shows the assembly of FIG. 3 incorporated into a substrate comprising a plurality of material layers and having an optical window provided between the embedded connector component and the surface of the substrate, which forms part of the first embodiment of the optical connector arrangement according to the present invention;

FIG. 5 shows the first embodiment of the optical connector arrangement according to the present invention comprising the assembly of FIG. 4 coupled to a surface connector component;

FIG. 6 shows a reflector support for use in a second embodiment of an embeddable connector component according to the present invention;

FIG. 7 shows a cross section taken through the mirrored support of FIG. 6 according to the second embodiment of an embeddable connector component according to the present invention;

FIG. 8 shows a cross section taken during assembly through a third embodiment of an optical connector arrangement according to the present invention;

FIG. 9 shows a cross section taken through the assembled third embodiment of the optical connector arrangement according to the present invention;

FIG. 10 shows a cross section taken through a fourth embodiment of an embedded connector component according to the present invention; and

FIG. 11 shows an aircraft system incorporating an optical connector arrangement according to an embodiment of the present invention.

### DETAILED DESCRIPTION OF EMBODIMENTS OF THE INVENTION

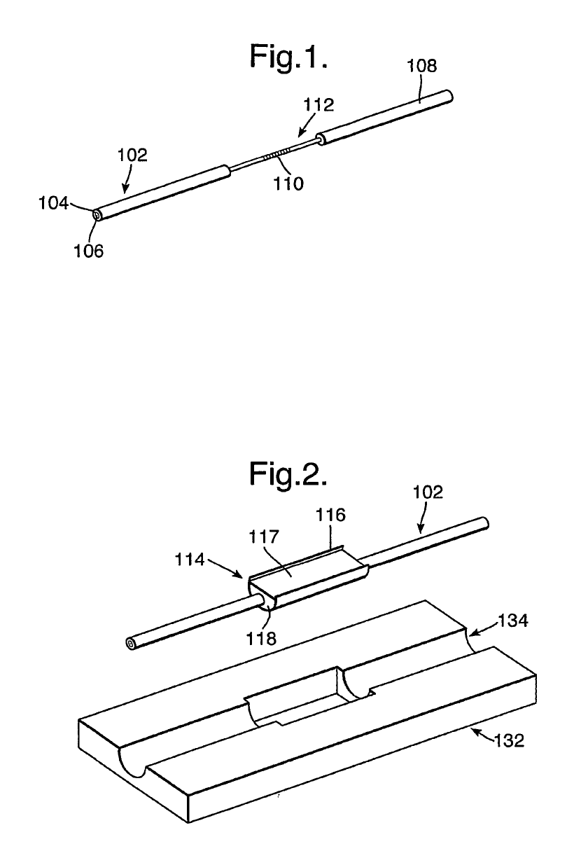

FIG. 1 shows a segment of a fibre optic 102 incorporating a grating 110 for use in an optical connector arrangement 100. The fibre optic comprises a fibre core 104 surrounded by a fibre cladding 106. The fibre cladding 106 is surrounded by a fibre jacket 108. The fibre optic 102 can be formed from standard telecommunications fibre, such as, for example, Corning SMF28 fibre that operates as single mode fibre when using light having a wavelength of 1550 nm.

The fibre optic 102 incorporates a stripped fibre portion 112 at which the fibre cladding 106 has been exposed by removing a portion of the fibre jacket 108. The fibre jacket 108 can be removed using standard techniques, such as, for example, by dissolving polyimide jacket material in an acid, or by removing an acrylic material either by physical or chemical stripping using methylene dichloride.

Grating 110 is written into the stripped fibre portion 112. The grating is created by inducing refractive index variations in the fibre core 104 and/or fibre cladding 106. Such refractive index variations may be periodic, or can vary, such as, for example, where a chirped Bragg grating is provided.

Various techniques for writing gratings are known. One such technique is to use an interferometer to provide an interference pattern generated by two components of a split ultra violet (UV) optical beam. Refractive index variations are induced in a fibre optic, placed in the region where the two components interact to form the interference pattern, by the UV intensity variations of the interference pattern. The period and length of the grating can be controlled. For example, the grating period can be controlled by adjusting an angle of incidence between the two components of the UV optical beam, and the grating length may be controlled by provision of an optical mask of predetermined dimensions. Further details of examples of suitable gratings and methods for their manufacture are described in various of the documents listed above.

FIG. 2 shows an embeddable connector component 114 incorporating the segment of fibre optic 102 during assembly the optical connector arrangement 100. It is possible, though by no means essential, that an embeddable connector component can itself be made to fit flush with a surface of a finished substrate surface.

The embeddable connector component 114 is made by optically coupling the fibre optic 102 to a reflector 116. The reflector 116 has a curved mirror coated inner surface 117. In the illustrated embodiment, the reflector 116 is formed by cutting a capillary tube having an outer diameter of 1 mm and an inner diameter of 0.25 mm in half and sputter coating the inner surface 117 to provide a mirrored coated surface. For example, gold, silver, chromium and/or aluminium may be provided to form a mirror coating. The fibre optic 102 has a diameter of 0.125 mm and so its core lies 0.0625 mm above the surface of the reflector 116, at a point that provides optimal radiation transfer when the grating is a blazed grating orientated towards the reflector 116.

The reflector 116 may be made from an inert material that has a low reactivity with any materials with which it is to be placed in contact. For example, the reflector 116 may be made of a glass capillary or an inert metal alloy, such as ARCAP. The inner surface 117 may be coated using a sputter deposition. Suitable coating materials may include, for example, one or more of: gold, silver, aluminium and chromium. The fibre optic 102 is then placed proximal the inner surface 117 and potted using potting material 118. The potting material 118 may be, for example, a material such as Araldite 2020. In various embodiments, the fibre optic 102 and the reflector 116 are bonded so as to lie in as close a proximity as possible.

The fibre core 104 may lie near to a focal point (or lie near a point lying on a focal cusp) of the reflector 116 to provide for an improved optical coupling efficiency between the fibre core 104 and the reflector 116. Both the stripped fibre portion 112 and part of the fibre jacket 108 either side of the stripped fibre portion 112 may be potted with the reflector 116. A separate reflector formation (not shown) may be provided to support the stripped fibre portion 112. The known diameter of fibre jacket 108 can be used to set the relative positions of the stripped fibre portion 112 and the inner surface 117 of the reflector 116 by positioning the parts of the fibre cladding 106 found either side of the stripped fibre portion 112 against the inner surface 117. The parts of the fibre jacket 108 found either side of the stripped fibre portion 112 may additionally provide support for the stripped fibre portion 112 during the potting procedure, thereby reducing the chance of damaging the stripped fibre portion 112.

A support layer 132 is also provided. The support layer 132 can be used as part of a substrate, that may, for example, be incorporated into a panel for an aircraft or other vehicle. The support layer 132 has a recess 134 shaped to receive the embeddable connector component 114. The recess 134 can be provided by machining the support layer 132. For example, the support layer 132 can be machined using an Excimer laser to provide a recess. Various formations may be provided in the recess 134 to support and/or orientate the embeddable connector component 114.

The embeddable connector component 114 may be completely sealed. Hence, it can be protected from the ingress of various materials (such as, for example, epoxy resin or a component thereof) that might be used during manufacture, e.g. the resin of composite materials.

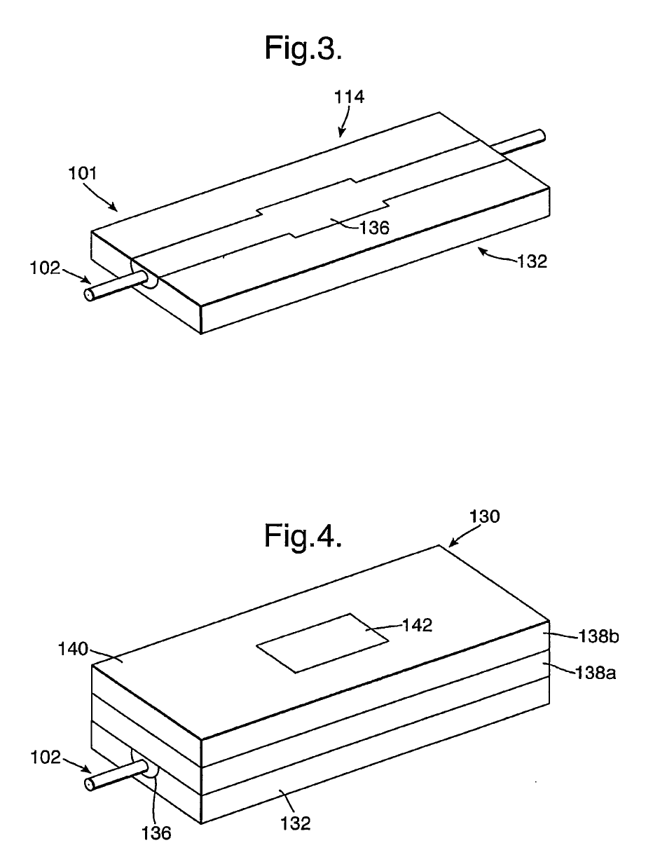

FIG. 3 shows the connector component 114 embedded in the support layer 132, together forming an assembly 101, during assembly of the optical connector arrangement 100. The connector component 114 is placed into the recess 134 using potting material 136. Potting material 136 preferably has substantially the same refractive index as the potting material 118 in order to minimise reflection losses. Once potted, the surface of the support layer 132 may be processed to smooth it out, if desired. Where, for example, the support layer 132 is made using a composite material, it may be cured before, during or after potting of the connector component 114. Generally, the connector component 114 will be made prior to being embedded.

FIG. 4 shows the assembly 101 of FIG. 3 incorporated into a substrate 130 comprising a plurality of material layers 132, 138a, 138b and having an optical window 142 provided between the embedded connector component 114 and the surface 140 of the substrate 130. The assembly 101 forms part of the optical connector arrangement 100. Where desired, various surface formations (not shown) may be provided at the surface 140 to provide attachment/alignment features that are useful when surface modules 120 and/or consolidation tooling (see below) is/are to be attached.

The optical window 142 is formed by providing substrate material layers 138b, 138b over the support layer 132, and may be fabricated or processed to fit flush to the surface 140. The substrate material layers 138b, 138b are provided with excised apertures that are aligned with the underlying embedded connector component 114. The apertures may be provided with apertures that are aligned then filled with an optical window material, such as, for example, Araldite 2020. Glass (or other material) windows may be provided as an alternative, or in addition to such optical window materials. Alternatively, one or more of the substrate material layers 138b, 138b may be provided with an optical window material that is cured before the various substrate material layers 138b, 138b are assembled over the support layer 132. It is noted that the relative orientations of any fibres that may be used in various substrate layers may be disposed so as to provide various desirable physical characteristics for the substrate 130.

When one or more material layers 132, 138a, 138b are provided to make up the substrate 130, consolidation tooling (not shown) may placed upon, or attached at, the surface 140. The consolidation tooling acts to compress the material layers 132, 138a, 138b, to ensure that the layers consolidate to a desired density and surface shape. Consolidation also helps provide a securely embedded fibre optic 102. Many forms of consolidation tooling are available, including, for example, a heavy weight or various tooling that positively engages the surface 140, for example by subjecting the substrate 130 to a partial vacuum, such consolidation tooling may comprise a vacuum bag provided over the surface 140. External pressure may also be applied outside the vacuum bag as necessary.

Composite materials that are used to provide a substrate 130, or a part thereof, generally need to be cured. Curing can be implemented by various methods such as chemical, pressure and/or heat induced variations in the physical/chemical composition of a resin, either impregnated into fibres or found in layers pre-impregnated with a resin material.

As an example, the substrate 130 may be made using a plurality of composite material layers that have been pre-impregnated with BMI resin material. For this material, the substrate 130 is subject to a temperature of 190° C. for 7 hours at a pressure of 100 psi, before being subject to a post-cure temperature of 245° C. Where standard epoxy resin is used, the substrate 130 is subject to a temperature of 175° C. for 5 hours at a pressure of 90 psi, before being subject to a post-cure temperature of 210° C. Where various other materials are used, a post-cure step may not be necessary.

Another technique to make a composite material is to use a resin transfer moulding (RTM) technique. The RTM technique uses fibre pre-form layers that are placed into a closed mould. Resin is injected into the mould at low pressure (<100 psi for thermosetting resin, subsequently cured at a temperature of 175° C. at 70 psi) to fill the voids in the fibre pre-form layers. The mould is then subject to a curing treatment to create the composite material.

Once any curing process has taken place, any consolidation tooling is removed from the substrate 130, and any additional processing, such as, for example, polishing, fitting and/or machining can be undertaken.

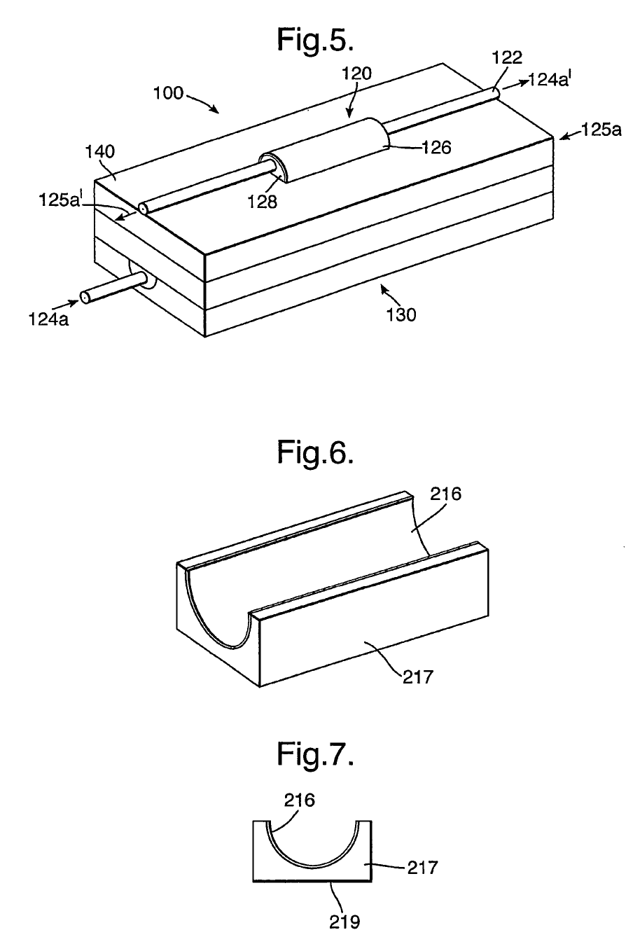

FIG. 5 shows the optical connector arrangement 100 comprising the substrate 130 coupled to a surface connector component 120. The optical window 142 formed in the substrate 130 may be bonded to a corresponding optical window in the surface connector component 120. For example, Epo-Tek 353ND optical glue may be used to provide an indexed matched join between the two optical windows and bond the periphery of the surface connector component 120 to the surface 140.

The surface connector component 120 comprises a surface fibre 122, including a fibre optic grating (not shown) optically coupled to a surface reflector 126. The surface reflector 126 is potted into the surface reflector 126 using potting material 128. The surface connector component 120 is manufactured in a manner similar to the embeddable connector component 114 described herein, and includes a polished optical window (not shown) for coupling light both from and to the surface fibre 122.

The principle of the reciprocity of light ensures that the surface connector component 120 can be used to couple radiation (such as, for example, UV, optical radiation, infrared radiation etc.) both from and into the surface fibre 122. In the discussions herein, it is understood that this principle of reciprocity applies to all embodiments and aspects of the invention.

First and second input beams 124a, 125a and respective corresponding first and second output beams 124a′, 124b′ shown in FIG. 5 illustrate the path of radiation provided from the embedded connector component 114 to the surface connector component 120; it being understood that these paths are reversible due to the principle of the reciprocity of light.

FIGS. 6 and 7 shows a reflector support 217, in perspective and cross sectional views respectively, for use in an embeddable connector component. The reflector support 217 is made from a solid material that has a low-reactivity with any surrounding substrate material in which it is to be embedded. In one example, the reflector support 217 is made of a metal alloy, such as, for example, PEEK, ARCAP etc. Such a material has a low reactivity to resin materials that are used to form composite substrates. Use of these materials thereby provides a reflector element that has long term stability when embedded in such a composite substrate.

The reflector support 217 is shaped to fit into a recess in a support layer. The recess allows the reflector support 217 to be keyed into a predetermined position. By providing a flattened bottom face 219, the alignment between the reflector support 217 and the surface of a substrate can be facilitated. Furthermore, rotation of the reflector support 217 is also inhibited by provision of the flattened bottom face 219.

During assembly into an optical connector arrangement, a fibre optic is optically coupled to a reflector 216 provided on the reflector support 217, for example using potting as herein described. The reflector 216 can be provided by sputter coating the reflector support 217, using, for example, one or more of gold, silver, aluminium and chromium.

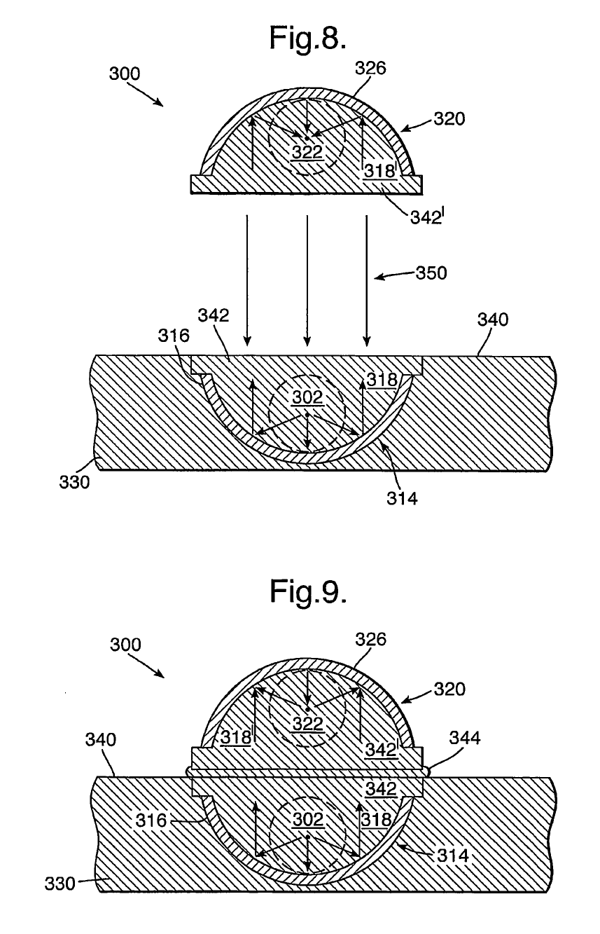

FIG. 8 shows a cross section taken during assembly through an optical connector arrangement 300. The optical connector arrangement 300 comprises an embedded connector component 314 embedded in a substrate 330. To form the optical connector arrangement 300, a surface connector component 320 is coupled to the embedded connector component 314 by bringing the surface connector component 320 into optical contact with the embedded connector component 314 at the surface 340 of the substrate, as indicated by arrows 350.

The embedded connector component 314 comprises a curved reflector 316 embedded in the substrate 330. Jacketless fibre optic 302 is potted into position adjacent the concave surface of the reflector 316 using potting material 318. The fibre optic 302 and the reflector 316 are optically coupled by way of a grating (not shown). The potting material 318 binds the fibre containing the grating to the reflector 316 and provides the optical window 342 at the surface 340 of the substrate 330.

Radiation emitted from the fibre optic 302 by the grating passes through the optical window 342 when emitted from the grating in a direction towards the surface 340 or is reflected towards the surface 340 when it is emitted from the grating in a direction towards the reflector 316. The reflector 316 thus increases the amount of radiation emitted from the grating which is directed towards the surface 340. Equally, the reflector 316 increases the radiation gathering efficiency of the embedded connector component 314 for radiation passing through the optical window 342 towards the fibre optic 302 and/or the reflector 316.

A blazed Bragg grating may be provided in the fibre optic 302 to direct radiation in any desired direction. In various embodiments, the blazed grating is orientated towards the reflector 316. Embodiments incorporating blazed gratings can enable a high coupling efficiency (˜10%) to be obtained between the embedded connector component 314 and a surface connector component 320. Further, coupling efficiency of such embodiments is fairly non-sensitive to the precise positioning of the fibre relative to the reflector 316.

The optical connector arrangement 300 also comprises a surface connector component 320. The surface connector component 320 comprises a curved reflector 326. The surface connector component 320 may form part of a surface connector. For example, the surface connector component 320 may be potted into a protective material, such as, for example, a resilient compound (not shown) used to provide a low-profile blister module. A fibre optic 322, stripped of at least a portion of its jacket, is potted into position adjacent the concave surface of the reflector 326 using potting material 318′. The fibre optic 322 and the reflector 326 are optically coupled by way of a grating (not shown) written into the fibre optic 322. The potting material 318′ binds the grating to the reflector 326 and provides an optical window 342′.

Radiation emitted from the fibre optic 322 by the grating passes through the optical window 342′ when emitted from the grating in a direction away from the reflector 326 or is reflected towards the optical window 342′ when it is emitted from the grating in a direction towards the reflector 326. The reflector 326 thus increases the amount of radiation which is collected by, or emitted from, the grating.

FIG. 9 shows the assembled optical connector arrangement 300. Optical windows 342 and 342′ are affixed to one another in close proximity using fixant 344. The fixant 344 preferably index matches to both the optical windows 342, 342′. For example, the fixant 344 may comprise Epo-Tek 353ND optical glue used to provide an indexed matched join between the optical windows 342 and 342′.

By providing the reflectors 316, 326 in fairly close proximity, to provide, for example, an essentially cylindrical reflector comprising the pair of reflectors 316 and 326, the efficiency of the optical connector arrangement 300 is improved. Moreover, the need to provide accurately positioned fibre gratings is reduced or removed.

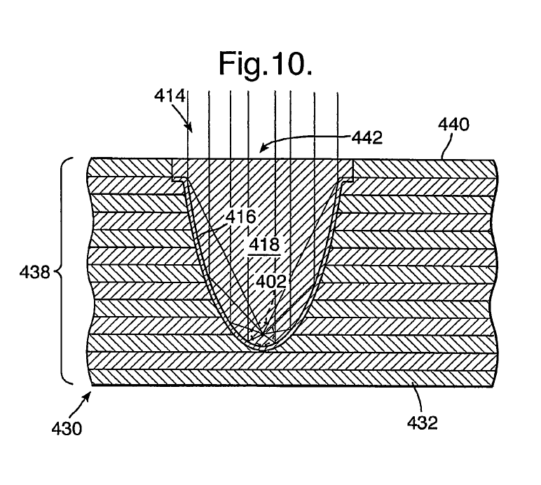

FIG. 10 shows a cross section taken through an embedded connector component 414. The embedded connector component 414 is embedded in a substrate 330. The substrate 330 is formed of support layer 432 and substrate material layers 438. The substrate material layers 438 are provided with incisions of varying size and together form a recess for accommodating the embedded connector component 414.

The embedded connector component 414 comprises a curved reflector 416 embedded in the substrate 430. A fibre optic 302, stripped of a portion of its jacket, is potted into position adjacent the concave surface of the reflector 416 using potting material 418. The fibre optic 402 and the reflector 316 are optically coupled by way of a grating (not shown). The potting material 418 binds the grating to the reflector 416 and provides the optical window 442 at the surface 440 of the substrate 430.

The reflector 416 has a part elliptically shaped or parabolic-shaped cross-section along its length. The central axis of the fibre optic 402 is disposed at the focal point of the reflector 416. Radiation emitted from the fibre optic 402 that is incident on the reflector 416 is emitted as a collimated beam through the optical window 442. By providing substantially collimated/low-divergence radiation beams, optical fibres 402 may be deeply embedded in the substrate 430 and/or various surface connector components (not shown) may be disposed away from the substrate surface 440.

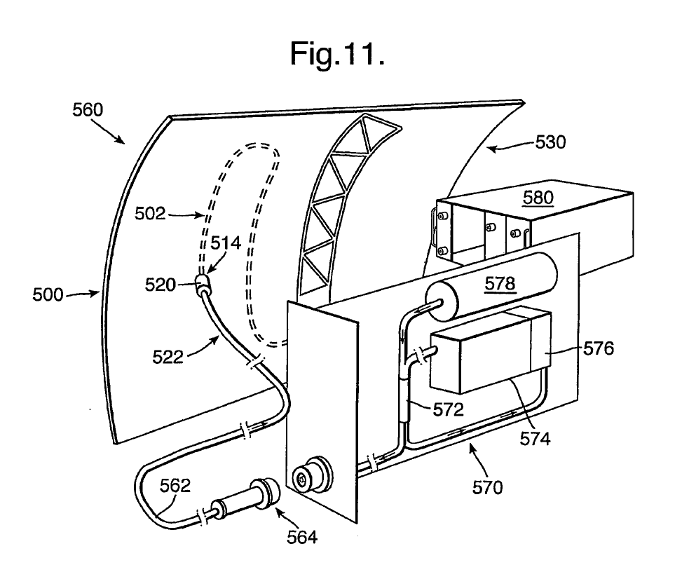

FIG. 11 shows an aircraft system 560 incorporating an optical connector arrangement 500. The optical connector arrangement 500 incorporates an embedded fibre sensor 502 embedded in a panel of composite material 530 connected to an embedded connector component 514. The embedded fibre sensor 502 is interrogated by inputting pump radiation through a surface connector component 520 and analysing any retro-propagating radiation.

The surface connector component 520 connects to an avionics card module 570, housed in an avionics rack 580, via fibre cable 522 and fibre connector 564. The avionics card module 570 comprises a fibre coupler 572 for splitting a pump radiation beam generated by a broadband light source 578. Part of the split pump radiation is directed to the fibre connector 564 for transmittal to the embedded fibre sensor 502, and the other part is directed to photodiode 576. Retro-propagating radiation from the embedded fibre sensor 502 is directed via the fibre coupler 572 to tuneable filter 574. Analysis of the photodiode 576 and/or tuneable filter 574 outputs enables information relating to the physical state of the embedded fibre sensor 502, and thus the panel of composite material 530, to be determined.

Optical connector arrangements of the type described herein allow waveguides, such as fibre optics, to be embedded at various controllable depths within a substrate material. Such optical connector arrangements can also provide low loss connections from such an embedded waveguide to a surface module or connector. Many such optical connector arrangements will be apparent to those skilled in the art. Various embodiments of the invention provide that edge trimming of panels incorporating the waveguide assembly, which is often necessary when fitting such panels to, for example, an aircraft frame, does not affect the optical connector arrangements. Moreover, such optical connector arrangements may provide surface accessible connectors to which low-profile surface connectors may be easily attached.

Various embodiments of the invention may provide one or more advantages: for example, substrates may be provided with optical windows that fit flush with the substrate surface, thereby allowing the surface to be processed to provide a smooth finish without there being a protruding connector. Additionally, such optical windows may allow for the bonding of a surface module directly onto the surface, for example, by using an index matching compound/glue/resin or the like, thereby providing an optical connector arrangement connection that is easy to provide and secure. Various embodiments of the invention may provide a low-profile optical connector arrangement having a reduced susceptibility to being knocked about.

Various embodiments of the invention may provide a substantially collimated beam, thereby making alignment of connector components easier. One or more gratings may be provided embedded in a substrate and/or surface connector component to provide for wavelength division multiplexing (WDM). One or more such grating may be provided as part of a WDM device/system, thereby providing filtering and/or wavelength selective tap off points without the need to provide separate WDM splitters and separate output connectors. Moreover, fibre gratings are generally stable and can remain protected in a substrate. Additionally, the coupling coefficient of such fibre gratings are selectable during manufacture and can thus be tailored for use in numerous diverse applications.

Those skilled in the art will be aware that various lenses, mirrors and/or, waveguides can be incorporated into optical connector arrangements according to the present invention. They will also be aware that fibre optics could be substituted for various waveguides that may be single/multimode. Such a waveguide may be selected for single and/or multimode operation at various wavelengths, such as, for example, one or more of: UV, visible, near-infrared and infrared wavelengths. A fibre optic may be completely or partially embedded in the support layer/substrate. A fibre optic may be terminated into various connectors as desired. A plurality of embedded connector components may be provided along the length of a fibre optic. In various embodiments, the fibre optic may terminate with a stripped fibre portion used to terminate the fibre optic into a connector component.

Those skilled in the art will also be aware that in various embodiments substrate materials may comprise composite materials. Additionally, those skilled in the art will realise that various optical connector arrangements can be provided on one or more surfaces of a substrate. Both the substrate and/or any layers forming a part thereof may comprise composite materials. Such composite materials may, for example, be made using layers of material comprising generally aligned fibres of glass, carbon, metal and/or Kevlar, impregnated or pre-impregnated with a resin material, and combinations of two or more such materials. The general orientation of the fibres of neighbouring layers can be varied to provide enhanced mechanical properties in the finished composite material. In other embodiments, materials having non-generally aligned strengthening fibres may be used.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features from dependent claims may be combined with those of the independent claims and features from respective independent claims may be combined in any appropriate manner and not merely in the specific combinations enumerated in the claims.

1. An optical connector arrangement comprising:
a connector component embedded in a substrate material, said embedded connector component including a fibre optic grating optically coupled to a reflector for directing radiation emitted from said fibre optic grating to a surface of said substrate material; and
a surface connector component for collecting radiation emitted from the surface of said substrate material.

2. The optical connector arrangement of claim 1, wherein the substrate material is a composite material.

3. The optical connector arrangement of claim 1, wherein the substrate comprises a plurality of material layers.

4. The optical connector arrangement of claim 1, wherein an optical fibre comprising the grating is bonded to the reflector using an index matching material.

5. The optical connector arrangement of claim 1, wherein the embedded connector component is potted into a recess in the substrate using an optically transparent material.

6. The optical connector arrangement of claim 5, wherein the optically transparent material is formed flush with the surface of said substrate material.

7. The optical connector arrangement of claim 1, wherein the reflector has a curved reflecting surface.

8. The optical connector arrangement of claim 7, wherein the curved reflecting surface is part of a cylindrical surface.

9. The optical connector arrangement of claim 7, wherein the curved reflecting surface has a substantially constant part elliptically shaped or parabolically shaped cross-section along its length.

10. The optical connector arrangement of claim 9, wherein an axis of the fibre optic grating lies proximal to a focal point of said part elliptically shaped or parabolically shaped cross-section along at least part of the length of said curved reflecting surface.

11. The optical connector arrangement of claim 1, wherein the surface connector component comprises a further optical fibre incorporating a grating for optically co-operating with the fibre optic grating provided in said substrate.

12. The optical connector arrangement of claim 1, wherein a grating comprises one or more of: a Bragg grating, a slanted/blazed Bragg grating and a long period grating.

13. The optical connector arrangement of claim 1, wherein radiation emitted from the surface of said substrate material is substantially collimated.

14. An embeddable connector component for embedding in a substrate material and/or for use in a surface connector component, said embeddable connector component including a fibre optic grating optically coupled to a reflector for directing radiation emitted from said fibre optic grating to a surface of a substrate material.

15. The embeddable connector component of claim 14, wherein an optical fibre comprising the grating is bonded to the reflector using an index matching material.

16. The embeddable connector component of claim 14, wherein the reflector has a curved reflecting surface.

17. The embeddable connector component of claim 16, wherein the curved reflecting surface is part of a cylindrical surface.

18. The embeddable connector component of claim 16, wherein the curved reflecting surface has a substantially constant part elliptically shaped or parabolically shaped cross-section along its length.

19. The embeddable connector component of claim 18, wherein an axis of the fibre optic grating lies proximal to a focal point of said part elliptically shaped or parabolically shaped cross-section along at least part of the length of said curved reflecting surface.

20. The embeddable connector component of claim 14, wherein said grating comprises: a Bragg grating, a slanted/blazed Bragg grating or a long period grating.

21. The embeddable connector component of claim 14, wherein radiation reflected by said reflector is substantially collimated.

22. A panel for a vehicle fuselage, component, body or hull, comprising the embeddable connector component according to claim 14.

23. An vehicle comprising a composite panel according to claim 22.

24. A method of manufacturing a vehicle, comprising incorporating a composite panel according to claim 22 into a vehicle fuselage, component, body or hull.

25. A surface connector component for use in the optical connector arrangement according to claim 1.

26. A method of manufacturing an optical connector arrangement comprising: embedding a connector component in a substrate material, said embedded connector component including a fibre optic grating optically coupled to a reflector for directing radiation emitted from said fibre optic grating to a surface of said substrate material; and providing a surface connector component for collecting radiation emitted from the surface of said substrate material.

27. The method of claim 26, wherein the step of embedding the connector component in a substrate material comprises providing a plurality of composite material layers to form a composite material.

28. The method of claim 27, wherein each composite material layer comprises respectively aligned material fibres.

29. The method of claim 28, further comprising selecting the material fibres from one or more of the following materials: carbon, glass, metal and Kevlar.

30. The method of claim 26, comprising potting the connector component into a recess in the substrate material using an optically transparent material.

31. The method of claim 30, comprising forming the optically transparent material flush with the surface of said substrate material.

32. The method of claim 26, comprising providing the surface connector component with a further optical fibre incorporating a grating.

33. The method of claim 26, comprising selecting a grating from one or more of: a Bragg grating, a slanted/blazed Bragg grating and a long period grating.

34. The method of claim 26, comprising forming the reflector from a cylindrical tube.

35. A method of manufacturing an embeddable connector component for use in an optical connector manufactured according to the method of claim 26, comprising bonding an optical fibre comprising the grating to a reflector using an index matching material.

36-40. (canceled)
